(19) United States
(12) Patent Application Publication
(10) Pub. No.: US 2022/0270595 A1
(43) Pub. Date: Aug. 25, 2022

(54) SPEECH TO TEXT CONVERSION OF NON-SUPPORTED TECHNICAL LANGUAGE

(71) Applicant: EVONIK OPERATIONS GMBH, Essen (DE)

(72) Inventors: Oliver KROEHL, Koeln (DE); Gaetano BLANDA, Haltern am See (DE); Stefan SILBER, Krefeld (DE); Inga HUSEN, Dortmund (DE); Michael BARDAS, Weiterstadt (DE); Thomas LANGE, Dortmund (DE); Ulf SCHOENEBERG, Berlin (DE)

(73) Assignee: EVONIK OPERATIONS GMBH, Essen (DE)

(21) Appl. No.: 17/439,891

(22) PCT Filed: Mar. 13, 2020
(86) PCT No.: PCT/EP2020/056960

§ 371 Date: Apr. 8, 2022

(30) Foreign Application Priority Data
Mar. 18, 2019 (EP) 19163510.1

(51) Int. Cl. G10L 15/19; G06F 40/166; G06F 40/253; G10L 15/30; G10L 15/22

(52) U.S. Cl. CPC G10L 15/19; G06F 40/166; G06F 40/253; G10L 15/30; G10L 15/22

(57) ABSTRACT

The invention relates to a computer-implemented method for converting speech to text. The method comprises:
receipt (102) of a speech signal (206), which contains general language terms and technical language terms;
input (104) of the received speech signal into a speech-to-text conversion system (226), which only supports the conversion of speech signals into a target vocabulary (234) which does not contain the technical language terms;
receipt (106) of a text (208), which was generated by the speech-to-text conversion system from the speech signal;
generation (108) of a corrected text (210) by automatically replacing terms and expressions from the target vocabulary in the received text with technical language terms according to an assignment table (238), which assigns at least one term or one expression from the target vocabulary, incorrectly recognized by the speech-to-text conversion system, to each of a plurality of technical language terms; and
output (110) of the corrected text to the user or to software and/or a hardware component for executing a function.

### TECHNICAL FIELD

The invention relates to a computer-implemented method for converting speech to text, in particular of technical language of the chemical industry.

### PRIOR ART

In chemical laboratories, due to the variety of risks arising both from substances and also from devices, a plurality of rules is applied in order to guarantee safe working conditions. Depending on the type of laboratory, the activities carried out there, and the substances used, the following safety guidelines may apply among others: personal protective equipment must be worn, which may also include safety glasses or a protective mask, and safety gloves, in addition to a laboratory coat. Bringing in and consuming food and drink is generally not permitted, and to prevent contamination, the laboratory work area and the office area, with desk, manuals, production documents in paper form, computer workstation and internet access, are spatially separated from one another. The spatial separation may stipulate that movement between the office area and laboratory area may only be carried out via a safety air lock. It may also be prescribed that safety clothing must be removed upon leaving the laboratory area.

The safety regulations sometimes make the work process significantly more difficult: in the case that a computer with internet and/or database access is only available in the office area, then the safety clothing must be removed for every operating step, and then donned again upon reentering the laboratory. Even if a computer with a keyboard and internet access is available inside the laboratory area, the keyboard may often not be operated with the gloves on. The gloves must be removed, and, if necessary, disposed of. After the conclusion of the work with the computer, the gloves must be pulled on again, in order to be able to continue with the laboratory work.

In individual cases, there are laboratory devices with a particularly large keyboard, for example, in the form of a large touchscreen, which facilitate input with gloves on. This specific hardware is, however, expensive and not available for all laboratory devices. In particular, standard computers and standard notebook computers do not have this type of “glove-compatible” keyboard.

The devices currently used in a laboratory are sometimes highly complex and are also designed for flexible interpretation of complex, text-based input. For example, M. Hummel, D. Porcincula, and E. Sapper describe in the European Coatings Journal (Jan. 2, 2019) in the Article “NATURAL LANGUAGE PROCESSING. A semantic framework for coatings science—robots reading recipes”, an automated laboratory system, which is trained to automatically analyze and interpret natural language text inputs and to carry out chemical syntheses based on the instructions in these natural language texts. However, even in this system, the user must manually interact with a user interface in order to input this text, so that gloves must be removed here as well.

The currently available possibilities for using or interacting with computers or computer-controlled machines and laboratory devices are therefore very limited and inefficient within the context of a chemical or biological laboratory.

### BRIEF DESCRIPTION OF THE INVENTION

The object of the present invention is to provide an improved method and end device according to the independent claims, which facilitates an improved control of software and hardware components in the laboratory context. Embodiments of the invention are specified in the dependent claims. Embodiments of the present invention may be freely combined with one another, when they are not mutually exclusive.

In one aspect, the invention relates to a computer-implemented method for converting speech to text. The method includes:
receipt of a speech signal of a user by an end device, wherein the speech signal contains general language terms and technical language terms spoken by the user;
input of the received speech signal into a speech-to-text conversion system, wherein the speech-to-text conversion system only supports the conversion of speech signals into a target vocabulary which does not contain the technical language terms;
receipt of a text, which was generated by the speech-to-text conversion system from the speech signal, from the speech-to-text conversion system;
generation of a corrected text by automatically replacing target vocabulary terms and expressions in the received text with technical language terms according to an assignment table, wherein the assignment table assigns terms in text form to one another, wherein the assignment table assigns at least one term or one expression from the target vocabulary, incorrectly recognized by the speech-to-text conversion system, to each of a plurality of technical language terms; and
output of the corrected text to software and/or to a hardware component, which is configured to execute a function according to information in the corrected text.

Embodiments of the invention are particularly suited for use in biological and chemical laboratories, as they do not have the disadvantages listed in the prior art. The speech-based input enables information to be entered as speech data into an end device at any location that a microphone is present, thus also within a laboratory area, without having to leave the laboratory workstation, remove gloves, or even completely interrupt the work.

It is true that, in the meantime, there are inexpensive end devices and powerful applications for speech-based input of commands in computer systems on the market, for example, Alexa (Amazon), Cortana (Microsoft), the Google Assistant, and Siri (Apple). However, these are conceived of to support end users during everyday activities, like shopping, the selection of a radio program, or in booking a hotel. The listed end devices and applications are thus conceived of for everyday situations and also only support general language terms. Even in the case that individual technical language terms (“technical terms”) are supported, the recognition accuracy in the listed systems is drastically reduced. However, in biology and particularly in the chemical industry, a plurality of technical terms is used in the laboratory context which do not occur in the general language. A high precision of speech recognition is also particularly important, especially in the context of a chemical laboratory. While small errors in everyday speech are often recognizable as such, and are recognizable as errors by users or by the receiving system, and may be easily corrected and compensated (for example, the incorrect recognition of the singular/plural form does does not mean that a corresponding entry into an internet search engine will return substantially different results), in the context of chemical syntheses, even the smallest deviations (e.g., “bis” instead of “tris”) may mean that a completely different substance is “recognized” as the one that the speaker actually meant, and the resulting product is either unusable or a potential hazard may even arise with risks to the health of the personnel or safe laboratory operation due to the use of incorrect substances. The listed speech-to-text conversion systems, conceived for everyday use, are therefore not suited for use in biological and chemical laboratories with corresponding risks.

Speech-to-text conversion systems also exist in part, which are designed specifically for the concerns and vocabulary of a certain subject area. For example, the company Nuance offers the “Dragon Legal” software for lawyers, which also includes includes legal technical terms in addition to the everyday vocabulary. However, it is disadvantageous that the vocabulary, which is necessary in a certain laboratory, e.g., in the area of manufacturing and analyzing paints and lacquers, is so specific and dynamically variable, that speech recognition software with chemical terms, which might be gathered from a standard chemistry text book, is often unsuitable in practice for a specific company or a specific branch of the chemical industry, as trade names of substances are often used in the laboratory. These trade names may change, or a plurality of new trade names are added each year for relevant products. In particular, a plurality of additional products and product variants, which may be used to manufacture paints and lacquers, arrive on the market each year with new trade names. Even if there were a speech-to-text conversion system, which achieves the accuracy of the everyday language systems from Google or Apple, and which would contain the more important chemical technical terms (which is not the case), this system would be ill-suited for use in practice due to the dynamics and plurality of the names, which play a practical role in the chemical laboratory, particularly in the manufacture of paints and lacquers, as most of the terms relevant in practice would not be supported or the vocabulary would be completely obsolete, at least after a few years.

According to embodiments of the invention, this problem is solved by resorting to a speech-to-text conversion system, which is known to not support the relevant technical terms. From the outset, there is no attempt to implement an expensive and complex special development, which servers only a very small market segment, and therefore, with some probability, would not achieve the recognition accuracy of the known large conversion systems from Amazon, Google, or Apple, as regards general language terms, which are also generally taken into account and must be correctly recognized in speech inputs, in addition to the chemical technical terms. Instead, embodiments of the invention take advantage of the already very good recognition accuracy of the existing service providers for general language terms, and carry out a correction before the output of the recognized text. Over the course of the correction, the incorrectly recognized terms are replaced by technical terms, based on the assignment table, such that a corrected text is created, which is finally output. The highly specific technical vocabulary, which must be continuously updated based on the dynamics of the field and the plurality of market participants, products and corresponding product names in order to keep the software practicable, is ultimately located in an assignment table. This may be kept up to date with very little effort.

New technical terms may simply be added, in that the assignment table is supplemented by the new technical terms, in each case together with one or more incorrectly recognized target vocabulary terms for this technical term. From a technical perspective, the storing and updating of the technical terms is thus completely decoupled from the actual speech recognition logic. This has the additional advantage that a dependency on a certain vendor of speech recognition services is avoided. The area of speech recognition is still young, and it is not yet predictable, which of the plurality of parallel solutions is the best selection in the long term with respect to recognition accuracy and/or price. According to embodiments of the invention, the link to a certain speech-to-text conversion system is carried out only in that the received speech signal is initially transmitted to this conversion system, and a (faulty) text is received. In addition, the assignment table contains falsely recognized terms of the target vocabulary, which were (incorrectly) returned for a certain technical term by this specific conversion system. Both may, however, be easily changed, in that a different speech-to-text conversion system is used to generate the (faulty) text, and the assignment table is newly created for this purpose by means of this different conversion system. Complex changes, for example, to the logic of a syntax parser and/or a neural network, are not necessary.

The method according to embodiments of the invention may also be advantageous for employees in the sales force of the chemical industry or chemical production, as these employees often already use a computer or at least a smartphone over the course of their work-related activities, and are less distracted from customers or their work by speech input into a correction software configured as an app or browser plugin than by text input via the keyboard.

According to embodiments of the invention, another advantage exists in that the end device merely records the speech signal, corrects the text, and outputs the result of the execution of a software function and/or hardware function based on the corrected text. The actual speech-to-text conversion of the speech signal into a text, thus the far more computationally intensive step, is carried out by the speech-to-text conversion system. The speech-to-text conversion system may be, for example, a server, which is connected to the end device via a network, for example, the internet. Thus, an end device with low processing power, for example a smartphone or a single-board computer, may also be used for the input and conversion of long and complex speech inputs.

According to one embodiment, the text generated by the speech-to-text conversion system is received by the end device. The end device then also carries out the text correction, wherein, depending on the embodiments, additional data processing steps may also be executed by the end device, e.g., the calculation or the receipt of probabilities of occurrence of individual terms in the text in order to take into account these probabilities during the replacement of terms and expressions based on the assignment table. This implementation variant is particularly advantageous when using comparatively powerful end devices, e.g., desktop computers in the laboratory area. For example, the end device may include a software program to receive the speech input, to forward the speech input via a speech-to-text interface to the speech-to-text conversion system, to receive the text from this conversion system, to correct the text based on the assignment table, and to output the corrected text to a software-based and/or hardware-based execution system. The software-based and/or hardware-based execution system is software or hardware or a combination of the two, which is configured to execute a function according to information contained in the corrected text, and preferably also to return a result of the execution. The result is preferably returned in a text form. The software program on the end device may be designed, e.g., as a browser plugin or browser add-on, or as a standalone software application, which is interoperable with the speech-to-text conversion system.

According to one alternative embodiment, the text generated by the speech-to-text conversion system is likewise received by the end device. The end device does not, however, subsequently carry out the text correction itself, but instead transmits the text via the internet to a control computer with correction software, which carries out the text correction based on the assignment table as described, and transfers the corrected text as an input to the execution system. The execution system may comprise software and/or hardware and be designed to execute a function according to the corrected text input. The execution system may be, e.g., laboratory software or a laboratory device. According to embodiments of the invention, the execution system returns the result of the execution of the corrected text to the control computer. This result is likewise preferably a text form. The result of the execution of the function is preferably returned by the control computer to the end device and/or output via other devices. The end device then outputs the result of the execution of the function according to the corrected text. The control computer may be implemented, e.g., as a cloud service or may be implemented on an individual server. This implementation variant may be advantageous for end devices of average performance, e.g., smartphones or control modules, which are integrated into individual laboratory devices or in systems for the analysis and/or synthesis of chemical substances. In this case, the end device still carries out the coordination of the data input, the data exchange with the speech-to-text conversion system, and the data exchange with the control computer. Optionally, the end device may output the result of the execution of the function according to the corrected text. In this embodiment, the control computer does not carry out the text correction function, but instead transmits the received text from the speech-to-text conversion system via the network to a correction computer, which carries out the text correction as described above using the table. The control computer receives the corrected text and forwards it via the network to an execution system, which executes a software function or hardware function according to the information in the corrected text. This embodiment may be advantageous, as a better separation is possible for the access rights to the functions and data of the control computer, on the one hand, and of the correction computer, on the other hand. If the text correction is executed on a separate cloud system, then a user may be granted access, for the purpose of updating the table, without also necessitating granting of access to sensitive data of the control computer, which may control, e.g., execution systems, like laboratory devices.

According to embodiments of the invention, the coordination of the data exchange with the speech-to-text conversion system, the text correction, and the forwarding of the corrected text to the execution system is thus completely carried out by the control computer, or organized and coordinated by the same. The end device is thus, according to several embodiments of the method, essentially a device with a microphone and an optional output interface for results of the execution of the corrected text. The end device may include, e.g., a speaker and client software, which is preconfigured for the data exchange with the control computer. This means that the client software on the end device is configured to transmit the speech signal to the control computer via a network and to receive a result of the execution of the corrected text in response thereto from the control computer. The end device is preferably designed as a portable end device. For example, the end device may be a single-board computer, e.g., a Raspberry Pi. For example, the software, “Google Assistant on Raspberry Pi” may be installed on this, which is accordingly configured so that the speech signals received by the end device are transmitted to the control computer. The address of the control computer is thus specified and stored in the end device. This may be advantageous, since a portable and very inexpensive end device may be provided for the purpose of simplified interaction with data processing devices and services within a laboratory. It is also possible to position this type of end device in any position in the space or laboratory. Users may take the end device with them into other spaces of the laboratory, or a larger laboratory may be inexpensively equipped with several end devices.

According to embodiments of the invention, the target vocabulary comprises a quantity of general language terms.

According to other embodiments of the invention, the target vocabulary comprises a quantity of general language terms and terms derived therefrom. These derived terms may be, for example, dynamically created concatenations of two or more general language terms. In the German language, for example, many words, in particular nouns, are formed by a combination of several other nouns. For example, the term “Schiffsschraube” [propeller] is so common that it is generally present in most general language dictionaries. A more rarely used term, like “Befestigungsschraube” [fastening screw], is, in contrast, lacking in most general language dictionaries. Many speech-to-text conversion systems may, however, also recognize terms like “Befestigungsschraube” [fastening screw] by means of heuristics and/or neural networks, if the individual word components “Befestigung” [fastening] and “Schraube” [screw] are part of the target vocabulary. In this sense, the term “Befestigungsschraube” [fastening screw] also then belongs to the target vocabulary of this type of speech-to-text conversion system.

According to other embodiments of the invention, the target vocabulary comprises a quantity of general language terms, supplemented by terms which are formed by combinations of recognized syllables. These speech-to-text conversion systems are thus more flexible in view of which terms may be recognized, since the recognition may be carried out—at least also—at the level of individual syllables, and not just individual words. However, the syllable-based recognition is also particularly prone to error, since the risk of an incorrect recognition of a word, which does not exist in any known vocabulary, is particularly large. Based on the finite nature of the quantity of supported or known syllables and the limitation in the quantity of combined syllables due to typical word lengths, the quantity of syllable-based generatable target words is also finite. Thus, speech-to-text conversion systems, which support syllable-based term generation, also have a finite target vocabulary despite their greater flexibility. Even if these systems are, based on their flexibility, theoretically also able to dynamically recognize many chemical terms, which are not contained in a previously-known lexicon, the recognition accuracy is low in practice, such that, with respect to practical applications, these systems also ultimately have a target vocabulary which does not contain or does not support these chemical terms.

In several embodiments of the invention, the target vocabulary comprises a quantity of general language terms, supplemented by terms derived therefrom and supplemented by words which are formed by combinations of recognized syllables. These conversion systems are also based on a target vocabulary, which does not contain the technical terms or may not recognize them in practical use with sufficient accuracy, but instead incorrectly recognizes other terms, typically general language terms, and converts them into text.

Thus, a plurality of different, currently available speech-to-text conversion systems may be used for the method according to embodiments of the invention, even if these systems essentially only “support” everyday language terms (i.e., to be able to correctly recognize and convert them into text with sufficient accuracy). The correction software is not fixed to a certain conversion system. In the case that a certain technical approach should prove to be particularly accurate and reliable over the course of time, then this may be used without essential components of a source code on the end-device side having to be reprogrammed.

According to embodiments of the invention, the technical language terms are terms from one of the following categories:
names of chemical substances, in particular of paints and lacquers or of additives in the paint and lacquer sector; in particular, the names relate to chemical names according to a chemical naming convention, e.g., according to IUPAC nomenclature;
physical, chemical, mechanical, optical, or haptic properties of chemical substances;
names (e.g., trade names or proper names assigned by users for the laboratory devices of a laboratory) of laboratory devices and devices in the chemical industry;
names of laboratory consumables and laboratory supplies;
trade names in the paint and lacquer sector.

According to embodiments of the invention, the technical language terms are terms from the field of chemistry, in particular the chemical industry, in particular the chemistry of paints and lacquers.

According to embodiments of the invention, the device or computer system, which carries out the text correction, thus, e.g., the end device or the control computer or another control computer, receives or calculates frequency information for at least some of the terms in the text which were generated from the speech signal by the speech-to-text conversion system. The respective frequency information indicates for terms in this text how frequently the occurrence of this term is to be statistically expected.

During the generation of the corrected text, only those terms of the target vocabulary in the received text, whose statistically-expected frequency of occurrence lies below a predefined threshold value according to the received frequency information, are selectively replaced by technical language terms according to the assignment table.

This may be advantageous, since the speech inputs of the user generally contain a mixture of general language terms and technical terms. The case may thus also occur, that terms of the target vocabulary, which are assigned to a technical term in the assignment table and would normally be replaced, are contained in the received text from the conversion system. For example, the returned text might contain the expression “polymer innovation”. Since the expression “polymer innovation” is assigned to a technical term “polymerization” in the assignment table, the expression is normally replaced by “polymerization” in the course of the text correction. If, however, the expression “polymer innovation” is assigned a frequency information, which represents a high probability of occurrence, the correction software assumes, based on this frequency of occurrence, that the expression “polymer innovation” is correct, even though this is assigned to a technical term in the assignment table, and, as a result of this, leaves the expression “polymer innovation” unchanged in the text. For example, a context analysis of the terms within the sentence or within the entire speech input may yield that the term “innovation” occurs frequently alone in the text, e.g., because the text comes from a sales representative who is describing the advantages of a certain polymer product. In this context, the expression “polymer innovation” may represent a correctly recognized expression. In a context, in which neither polymer nor innovation are mentioned alone, then the probability decreases. Terms also already have different probabilities of occurrence, regardless of context, as well.

The replacement of terms according to the assignment table, as a function of the probabilities of occurrence of the terms in the received text, may be advantageous, as, in a few individual cases, this prevents terms in the target language, which have a high probability of occurrence in the context of the respective text, from being incorrectly replaced by a technical term, and generating an error instead of a correction due to this this replacement.

According to one embodiment, the frequencies of occurrence of the terms of the text are calculated by the speech-to-text conversion system and returned, together with the text, by the speech-to-text conversion system to the end device or the control computer. For example, the speech-to-text conversion system may use hidden Markov models (HMMs) in order to calculate the probability of occurrence of a certain term in the context of a sentence. Additionally or alternatively, the speech-to-text conversion system may equate the frequency of occurrence of a term to the frequency of occurrence of the term in a large reference corpus. For example, the entirety of the texts of a newspaper across several years or an otherwise large data set of texts may function as the reference corpus. The ratio of the counted number of the terms in the corpus to the totality of the words in the corpus is the frequency of occurrence of this term observed in this reference corpus. In the case that the text correction is carried out by a separate correction computer according to embodiments of the invention, the frequency information, which the control computer has received from the speech-to-text conversion system, is forwarded to the correction computer.

According to another embodiment, the frequencies of occurrence of the terms of the text are calculated by the end device after receipt of the text. As already previously described, the calculation of the probabilities of occurrence of the individual terms or expressions may be calculated by means of HMMs, while taking the textual context of a term into account or based on the frequencies of the term in a reference corpus. For example, the entirety of the texts, previously received by the end device or by the control computer from the speech-to-text conversion system, may be used as the reference corpus.

Thus, according to embodiments, the calculation of the frequency information is carried out (e.g., by the end device or by a correction service) by means of a hidden Markov model. For example, the expected frequency of occurrence, thus the probability of occurrence, may be calculated as a product from the emission probabilities of the individual terms of a word sequence, as described, e.g., in B. Cestnik “Estimating probabilities: A crucial task in machine learning” In: Proceedings of the Ninth European Conference on Artificial Intelligence, pages 147-150, Stockholm, Sweden, 1990.

According to embodiments of the invention, the end device or the control computer also receives, in addition to the text, part-of-speech tags (POS tags)—for at least some of the terms in the text, which was generated from the speech signal by the speech-to-text conversion system. The POS tags are received from the speech-to-text conversion system and include at least tags for noun, adjective, and verb. It is also possible that the POS tags include additional types of syntactic or semantic tags. The exact composition of the POS Tags under consideration may also depend on the respective language. The technical language terms are stored, together with their POS tags, in the assignment table. During the generation of the corrected text, only those terms of the target vocabulary in the received text are replaced by technical language terms, whose POS tags match, according to the assignment table.

This may be advantageous, since the accuracy of the text correction step is increased thereby. The correctness of the POS Tags in the assignment table may be assumed, since the entries in the table are semi-automatically generated in that one or more speakers input a technical language term or a technical language expression into a microphone, the audio signal resulting from this is converted by the speech-to-text conversion system into an (incorrect) term or into an (incorrect) expression of the target vocabulary, and this incorrect term or incorrect expression is stored in the assignment table, linked to the technical language term. Since it is known what the technical language term stands for, and whether it is, for example, a noun, verb, or adjective, the technical language expression may also be stored, linked to the correct POS Tag, on the occasion of the generation or updating of the table. If, according to the assignment table, a certain term and a certain expression in the text must indeed be replaced by a technical language term, however the POS tags of the text to be replaced does not match the POS tag of the technical language terms, then this is an indication that the corresponding terms in the text might possibly be correct. The recognition rate of the POS tags is comparatively high, so that the quality of the correction step may be increased by this measure.

For example, a technical language term may be, e.g., the trade name “Platilon®”. It refers to thermoplastic polyurethane films from Covestro. This technical term is assigned a “noun” POS tag in the table. It is known about the speech-to-text conversion system that it has often incorrectly converted the spoken word, “Platilon”, to the target vocabulary term “Platin” [platinum]; therefore, the term “Platin” [platinum] of the target vocabulary is assigned to the technical term “Platilon” in the assignment table. However, in a current speech input of a user, the term was used adjectivally: “addition of a platinum- or zinc-based catalyst [ . . . ]”. Based on the POS tag for “Platin” [platinum] in the text returned by the conversion system, it may, if necessary, be recognized in this case, that the word “Platin” [platinum] is correct here and should not be replaced by “Platilon”.

According to embodiments of the invention, the method comprises steps for generation of the assignment table. For each of a plurality of technical language terms, at least one reference speech signal is recorded, which selectively reproduces this technical language term. The reference speech signal comes from at least one speaker. For technical language expressions as well, at least one reference speech signal, which selectively reproduces this technical language expression, may also be spoken by at least one speaker and recorded. The additional steps for terms and expressions are substantially identical, such that in the following, when a technical language term is discussed, a technical language expression is also understood to be included. Each of the recorded reference speech signals is input into the speech-to-text conversion system. The input may be carried out, in particular, via a network, e.g., the internet. For each of the input reference speech signals, the device, which has input the reference signals, receives at least one term of the target vocabulary, which was generated by the speech-to-text conversion system from the input reference speech signal. This device may be, e.g., the end device. The recording of the reference speech signals and the receipt of the (incorrect) terms or expressions of the target vocabulary, which ultimately function to generate or expand the assignment table, may, however, also be carried out by any other devices with a network connection to the speech-to-text conversion system. The input of the reference speech signals is preferably carried out via a device, which is most similar to the end device, in terms of construction and in respect to its position relative to noise sources, in order to ensure with the greatest degree of similarity that the same errors are reproducibly generated. The at least one term (which may also be an expression) of the target vocabulary, which is received for each of the technical language terms, represents an incorrect conversion, since the target vocabulary of the speech-to-text conversion system does not support the technical language terms. Finally, the assignment table is generated as a table, which assigns the at least one term of the target vocabulary, which was respectively generated by the speech-to-text conversion system from the reference speech signal containing this technical language term, in text form to each of the technical language terms, for which at least one reference speech signal was recorded.

This may be advantageous, since a table may be easily modified and supplemented, without having to change a source code, recompile a program, or retrain a neural network. Even in the case that a different speech-to-text conversion system is used, only the corresponding client interface has to be adapted, and the technical language expressions of the table have to be entered again by one or more speakers via a microphone, and transmitted to the new speech-to-text conversion system. The incorrect terms and expressions of the target language, returned by this new system, form the basis for the new assignment table. It is thus possible, without in-depth or complex changes and without retraining a language software, to functionally expand any everyday language speech-to-text conversion system so that spoken texts with technical language terms and expressions may also be correctly converted to text. The assignment table may be, for example, stored as a table of a relational database, or as a tab-delimited text file, or as another functionally comparable data structure.

According to embodiments of the invention, multiple reference speech signals in each case from different speakers are recorded for each of at least some of the technical language terms (or technical language expressions). The multiple reference speech signals reproduce this technical language term (or this technical language expression). The assignment table assigns multiple terms (or expressions) of the target vocabulary in text form to each of at least some of the technical language terms (or expressions). The multiple terms (or expressions) of the target vocabulary represent incorrect conversions, which the speech-to-text conversion system generated for the different speakers depending on their voices.

For example, a certain technical language term, like “1,2-methylenedioxybenzene” may be read aloud by 100 different persons and recorded with a microphone in each case as a reference speech signal. These persons are preferably those who are familiar with the pronunciation of chemical expressions. 100 reference speech signals are thus available for this one substance name. Each of these 100 reference speech signals is transmitted to the speech-to-text conversion system, and in response, 100 terms and expressions of the target vocabulary are returned, all of which do not correctly reproduce the actual technical name. The 100 returned terms are often identical, however, not always. Different persons have different voices, i.e., the speech input differs with respect to emphasis, volume, pitch, and articulation. It is therefore possible, that a certain speech-to-text conversion system returns multiple different incorrect terms or expressions, which are all entered into the assignment table, for one certain technical language term (or one certain technical language expression).

The inclusion of speech inputs of many different persons to generate the assignment table may be advantageous, as by this means the variability of human voices is better considered and an improved error correction rate may be achieved.

According to several embodiments of the invention, the end device or the computer system, which carried out the text correction, is configured to output the corrected text to the user via a speaker and/or a display. This has the advantage that the user once again has the opportunity to check the correctness of the corrected text.

According to several embodiments of the invention, the end device or the computer system, which carried out the text correction, is configured to output the result of the execution of the corrected text, which is provided by the execution system, to the user. The output may, for example, be carried out in that the result is displayed in text form on a screen of the end device. Additionally or alternatively, the result of the execution of the corrected text may be output via a text-to-speech interface and a speaker of the end device.

According to one embodiment, the execution system, which executes a function according to the corrected text, is software.

The software may be, for example, a chemical substance database. In particular, this software may be a database management system (DBMS) and/or an external software program which is interoperable with this DBMS, wherein the DBMS includes and manages the chemical database. The software is designed to interpret the corrected text as a search input and to determine and return information related to the search input in the database. The substance database may be, e.g., a component of a chemical system, e.g., an HTE system.

Additionally or alternatively, the software may be an internet search engine, which is designed to interpret the corrected text as a search input and to determine and return information from the internet related to the search input.

Additionally or alternatively, the software may be simulation software. The simulation software is designed to simulate properties of chemical products, in particular of lacquers and paints, based on a predefined recipe for generating the product. In this case, the simulation software interprets the corrected text as a specification of the recipe for the product, whose properties are to be simulated and/or the specification of the properties of the product.

Additionally or alternatively, the software may be control software to control chemical syntheses and/or to generate substance mixtures, in particular of paints and lacquers. The control software is designed to interpret the corrected text as a specification of the synthesis or of the components of the substance mixture.

According to additional embodiments of the invention, the output of the corrected text is carried out to the hardware component using the end device. The hardware component may be, in particular, a system for carrying out chemical analyses, chemical syntheses, and/or a system for generating substance mixtures, in particular of paints and lacquers. The system is designed to interpret the corrected text as a specification of the synthesis or of the components of the substance mixture or as a specification of the analysis to be carried out. The system may be a high throughput environment system (HTE system) for analyzing and producing paints and lacquers. For example, the HTE system may be a system to automatically test and automatically produce chemical products, as is described in WO 2017/072351 A2.

The output of the corrected text to a software component and/or hardware component may be very advantageous, in particular in the context of a biological or chemical laboratory, since the speech input is processed so that this may be directly forwarded to a technical system and may be correctly interpreted by the same, without the user having to remove gloves, for example, or having to leave the laboratory. For example, the hardware component may be a device or device module or a computer system inside of a chemical or biological laboratory. For example the hardware component may be an automated or semi-automated system for carrying out chemical analyses or for producing paints and lacquers.

This system for the analysis and/or synthesis of chemical products, in particular of paints and lacquers, may also be an HTE system.

The system for the analysis and/or synthesis of chemical products may be designed, for example, to automatically carry out one or more of the following work steps completely automatically in response to an input of the corrected text via a machine-machine interface:
rheological analyses of substances and substance mixtures;
measurement of the shelf life of substances and substance mixtures, in particular based on inhomogeneities and the tendency toward sedimentation in liquid substance mixtures; for example, this analysis may be carried out based on optical measurements in cuvettes after sampling;
pH value determination of substances and substance mixtures;
foam tests of substances and substance mixtures, in particular the measurement of the defoaming effect and the measurement of foam degradation kinetics;
viscosity measurements of substances and substance mixtures; the viscosity measurement may include, in particular in highly viscous substances or mixtures, an automated dilution step, since the viscosity is more easily ascertainable in a dilute solution; the viscosity of the original substance or substance mixture is calculated on the basis of the viscosity of the dilute solution;
measurement of the rub-out performance (abrasion test) of the substance or of the substance mixture, in particular of the finished product;
measurement of the color values of substances and substance mixtures using, for example, a spectrophotometer working with light scattering (so-called L-A-B values), haze, and gloss;
coating thickness measurement of substances and substance mixtures, which were applied on a planar surface under different, defined parameters (temperature, air humidity, surface finish of the planar surface, etc.);
image analysis method of images of substances and substance mixtures, in particular to characterize substance surfaces, e.g., quantity, size, and distribution of air bubbles or scratches in paints and lacquers.

The substances and substance mixtures may be, in particular, substances and substance mixtures which function to produce paints and lacquers. In addition, the substances and substance mixtures may be the end product, e.g., paints and lacquers in liquid and dry form, and also intermediate products, e.g., pigment concentrates, grinding resins, and pigment pastes, and the solvents used.

According to embodiments of the invention, the speech-to-text conversion system is implemented as a service, which is provided via the internet to a plurality of end devices. For example, the speech-to-text conversion system may be Google's “Speech-to-Text” cloud service. This may be advantageous, since a functionally powerful API client library is available, e.g., for .NET.

This may be advantageous, since the computationally-intensive conversion process of speech signals into text is not carried out on the end device, but instead on a server, preferably a cloud server, which has a higher computing power than the end device and which is designed for the fast and parallel conversion of a plurality of speech signals into recognized texts.

The end device may be, for example, a desktop computer, a notebook computer, a smartphone, a tablet computer, a computer integrated into a laboratory device, a computer locally coupled to a laboratory device, or a single-board computer (Raspberry Pi), in particular a single-board computer with microphone and speaker (“smart speaker”). The software logic, which implements the method according to embodiments of the invention, may be implemented exclusively on the end device, or in a distributed way on the end device and one or more additional computers, in particular cloud computer systems. The software logic is preferably software, which is device-independent and preferably also independent of the operating system of the end device.

The end device is preferably a device which stands within a laboratory space or which is operatively connected at least to a microphone within the laboratory space.

In another aspect of the invention, the invention relates to an end device. The end device comprises:
a microphone for receiving a speech signal of a user, wherein the speech signal contains general language terms and technical language terms spoken by the user;
an interface to a speech-to-text conversion system. This interface is designed to input the received speech signal into the speech-to-text conversion system. The speech-to-text conversion system only supports the conversion of speech signals into a target vocabulary which does not contain the technical language terms. The interface is designed to receive a text, which was generated by the speech-to-text conversion system from the speech signal.
A data memory with an assignment table of terms in text form. The assignment table assigns at least one term of the target vocabulary to each of a plurality of technical language terms or technical language expressions. The at least one term may be a term assigned to the technical language term or also an expression or a quantity of terms and expressions of the target vocabulary. The at least one term of the target vocabulary, assigned to the technical language term, is a term or an expression, which the speech-to-text conversion system incorrectly recognizes (and has incorrectly recognized over the course of the generation of the assignment table), when this technical language term is input in the form of an audio signal.
A correction program, which is designed to generate a corrected text by automatically replacing terms and expressions of the target vocabulary in the received text with technical language terms according to the assignment table; and
An output interface for the output of the corrected text to a user and/or to an execution system. The execution system is a software component and/or a hardware component and is configured to execute a function according to information in the corrected text.

The end device is preferably configured to receive a result of the execution via this or another interface from the software or hardware.

The end device preferably additionally includes an output interface, e.g., an acoustic interface, e.g., a speaker, or an optical interface, e.g., a GUI (graphic user interface) represented on a display. There may also be another interface, e.g., a proprietary data format, for the exchange of text data with a certain laboratory device.

In another aspect, the invention relates to a system including one or more end devices according to one of the embodiments described here. The system additionally comprises a speech-to-text conversion system. The speech-to-text conversion system includes:
an interface for receiving speech signals from each of the one or more end devices; and
an automated speech recognition processor for the generation of text from a received speech signal. The speech recognition processor only supports the conversion of speech signals into a target vocabulary which does not contain the technical language terms. The listed interface of the speech-to-text conversion systems is designed to return the text, generated from the received speech signal, to that end device, from which the speech signal was received.

According to some embodiments, in particular in which the text correction is not carried out by the end device but instead by the control computer or a correction computer, the system also comprises the control computer and/or the correction computer.

According to embodiments of the invention, the system additionally comprises the software or hardware component, which executes the function according to the corrected text.

A “vocabulary” is understood here as a linguistic area, thus a quantity of terms, of which an entity, e.g., a speech-to-text conversion system, may make use.

A “term” is understood here as a coherent sequence of signs, which appears within a certain vocabulary and represents an independent linguistic unit. In natural languages, a term has—in contrast to a sound or a syllable—an intrinsic meaning.

An “expression” is understood here to be a linguistic unit made from two or more terms.

A “technical language term” or “technical term” is understood here to be a term of a technical vocabulary. A technical language term is not part of the target vocabulary, and is typically also not a part of the general language vocabulary.

The statement, that a speech-to-text conversion system only supports the conversion of speech signals into a target vocabulary, means that terms from another vocabulary may either not be converted at all into text, or only converted into text with a very high error rate, wherein the error rate is above an error rate threshold value per term or expression to be converted, which must be considered as the maximum which is tolerable for a functioning conversion of speech into text. For example, this threshold value may be a probability of error per term or expression of more than 50%, preferably already more than 10%.

A POS tag (or part-of-speech tag) is understood here to be a specific label, which is assigned to each term in a text corpus, in order to indicate the part of speech and also often other grammatical categories, like tense, number (singular/plural), uppercase/lowercase, etc., which this term represents in its respective textual context. A set of all POS tags used in a corpus is designated as a tagset. Tagsets are typically different for different languages. Basic tagsets contain tags for the most common language components (e.g., N for noun, V for verb, A for adjective, etc.).

A “virtual laboratory assistant” is software or a software routine, which is operatively connected to one or more laboratory devices located in a laboratory and/or software programs in such a way that information may be received from these laboratory devices and laboratory software programs and commands to carry out functions may be transmitted from the laboratory assistant to the laboratory devices and laboratory software programs. Thus, a laboratory assistant has an interface for data exchange with and to control one or more laboratory devices and laboratory software programs. The laboratory assistant additionally has an interface to a user and is configured to facilitate easier use, monitoring, and/or control of the laboratory devices and laboratory software programs for the user via this interface. For example, the interface to the user may be designed as an acoustic interface or a natural language text interface.

The “end device” is understood here to be a data processing device (for example, a PC, notebook computer, tablet computer, single-board computing system, Raspberry Pi, smartphone, among others). The end device is preferably connected to a network connection.

A “reference speech signal” according to embodiments of the invention is a speech signal, which was captured by a microphone and which is based on a speech input, which was entered into the microphone by the speaker, not for the purpose of operating software or hardware, but instead to enable the generation or supplementation of the assignment table. The speech input is a spoken, technical language term or a spoken technical language expression, which is recorded in order to forward the corresponding speech signal to the speech-to-text conversion system, and, in response to this, obtain a term or an expression of the target vocabulary from the conversion system, which is based on an incorrect conversion.

### BRIEF DESCRIPTION OF THE DRAWINGS

Embodiments of the invention are explained in greater detail by way of example in the following images:

FIG. 1 shows a flow chart of a method for the speech-to-text conversion of texts with technical language terms;

FIG. 2 shows a block diagram of a distributed system for the speech-to-text conversion of texts with technical language terms;

FIG. 3 shows a block diagram of another distributed system for the speech-to-text conversion;

FIG. 4 shows a block diagram of another distributed system for the speech-to-text conversion; and

FIG. 5 shows a block diagram of another distributed system for the speech-to-text conversion in the context of a laboratory.

### DETAILED DESCRIPTION OF THE INVENTION

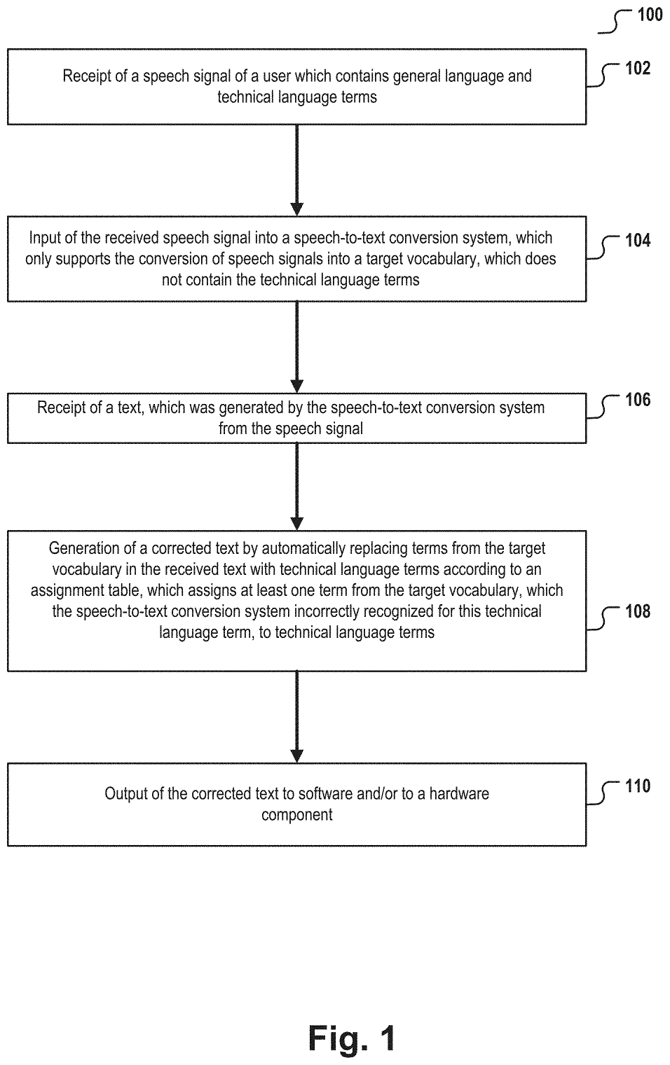

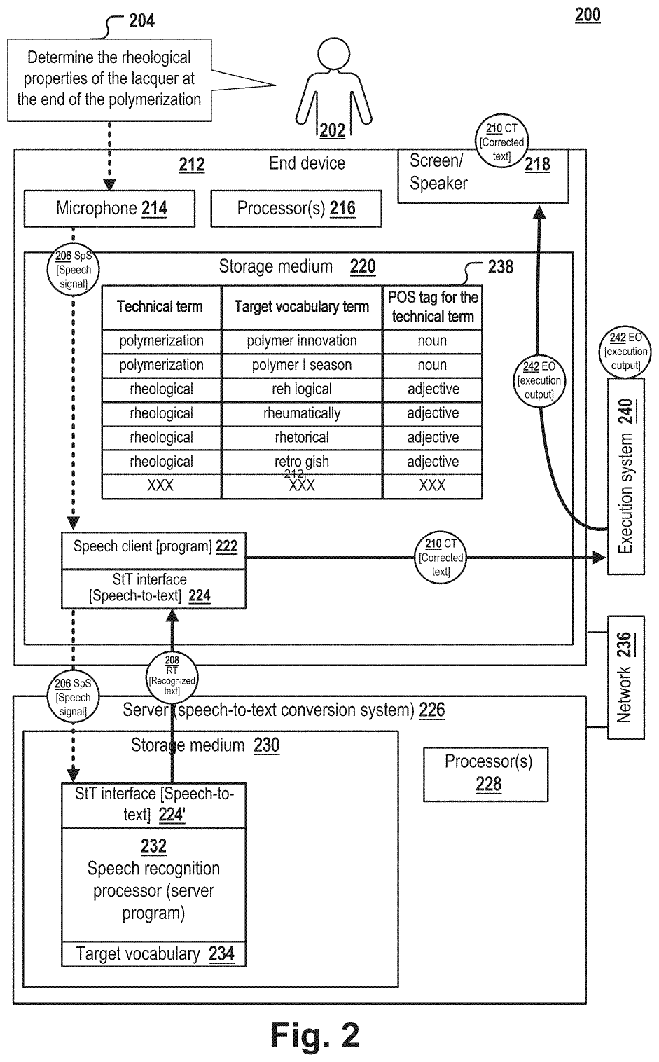

FIG. 1 shows a flow chart of a computer-implemented method for the speech-to-text conversion of texts with technical language terms. The particular advantage of the method is that an existing speech-to-text conversion system may be used for the recognition and conversion of texts with technical terms, and namely even in the case that this conversion system does not even support the technical language vocabulary. The method may be executed by an end device alone, or by an end device and additional data processing devices, for example, a control computer and/or a computer which provides a correction service via a network. Some possible architectures of distributed and non-distributed data processing systems, which may implement a method according to embodiments of the invention, are depicted in FIGS. 2, 3, and 4. In these figures, reference is also partially made to the description of the flow chart in FIG. 1.

The method may typically be used in the context of a chemical or biological laboratory. A series of individual analysis devices and a high throughput environment system (HTE system) are located in the laboratory. The HTE system includes a plurality of units and modules, which may analyze and measure different chemical or physical parameters of substances and substance mixtures, and which may combine and synthesize a plurality of different chemical products based on a recipe entered by a user. In addition, an end device, for example, a notebook computer of the laboratory worker with corresponding software in the form of a browser plugin, is located in the laboratory. The HTE system includes an internal database, in which recipes are stored, for example, of paints and lacquers and their raw materials, and also their respective physical, chemical, optical, and other properties. In addition, other relevant data may be stored in the database, for example, product data sheets from the producers of the substances, safety data sheets, parameters for the configuration of individual modules of the HTE system for the analysis or synthesis of certain substances or products, or the like. The HTE system is designed to execute analyses and syntheses based on recipes and instructions, which are entered in text form.

Frequent activities inside of a laboratory with the laboratory room number 22 relate, for example, to the following activities and to possible, related speech inputs of a laboratory worker 202 to prompt software or hardware to execute an operation:
The day before, the laboratory worker started an analysis of a certain lacquer with respect to its rheological properties, and would now like to retrieve the result stored in the database of the HTE system. Possible speech input: “CONTROL COMPUTER, show me the results of the rheological analysis on Feb. 24, 2019, by the HTE system in room 22.”
The laboratory worker would like to reduce costs and considers replacing a certain solvent «SOLVENT_EXPENSIVE» with a less expensive solvent «SOLVENT_INEXPENSIVE». The name «SOLVENT_INEXPENSIVE» is a trade name of the manufacturer. However, the worker is not certain whether the less expensive solvent is suitable for the lacquer to be produced, and would like to view the product data sheet, in which additional information regarding the chemical and physical properties of the inexpensive solvent are specified. Possible speech input: “CONTROL COMPUTER, display the product data sheet for «SOLVENT_INEXPENSIVE»” or “CONTROL COMPUTER, display the product data sheet for «SOLVENT_INEXPENSIVE» stored in the HTE database of room 22”.
After viewing the product data sheet for the solvent «SOLVENT_INEXPENSIVE», the laboratory worker is of the opinion that the solvent may be prospectively used for the production of the certain lacquer instead of the more expensive solvent. However, it is assumed that the recipe must be adapted somewhat, since multiple parameters, for example, pH value, rheological properties, polarity, and others deviate from those of the more expensive solvent. Since these properties interact with one another, it is not possible to manually identify the necessary adjustments to the recipe. Carrying out test series is labor intensive and costs time. However, the laboratory has software, which may predict (simulate) the properties of a chemical product, for example of paints and lacquers, on the basis of a certain recipe. The simulation may be based on, e.g., CNNs (convolutional neuronal networks). The laboratory worker would like to use this simulation software in order to simulate the predicted properties of a lacquer, based on a known recipe, in which the expensive solvent was replaced by the inexpensive one. Possible speech input: “CONTROL COMPUTER, prompt the HTE simulation software to calculate the properties of a lacquer with the following recipe: 70.2 g naphtenic oil, 4 g methyl n-amyl ketone, 1.5 g n-pentyl propionate, 1 g Ultrasorb, 50 g «LMGÜNSTIG»”.
The simulation has shown that the inexpensive solvent is not suited for the production of the lacquer. The laboratory worker would now like to search the internet for other solvents, which may replace the expensive solvent without degrading the quality of the product, in order to reduce costs. Possible speech input: “CONTROL COMPUTER, search the internet for «high viscosity solvents for lacquer production»”.

According to embodiments of the invention, all of these inputs and commands to the respective execution systems may be carried out without the user having to leave the laboratory room and/or remove gloves.

In a first step 102, laboratory worker 202 makes a speech input 204 into a microphone 214 of end device 212, 312. For example, the speech input may comprise one of the above-mentioned voice commands. The speech inputs generally include both general language and also technical language terms and expressions. Thus, for example, the terms or expressions “rheological”, “naphtenic oil', “methyl n-amyl ketone”, “n-pentyl propionate”are chemical technical terms and «LMGÜNSTIG» is a trade name of a chemical product. These terms or expressions are typically not included in the vocabulary (“target vocabulary”) supported by the commonly used, general language speech-to-text conversion systems.

Microphone 214 converts the speech input into an electronic speech signal 206. This speech signal is then input into a speech-to-text conversion system 226 in step 104.

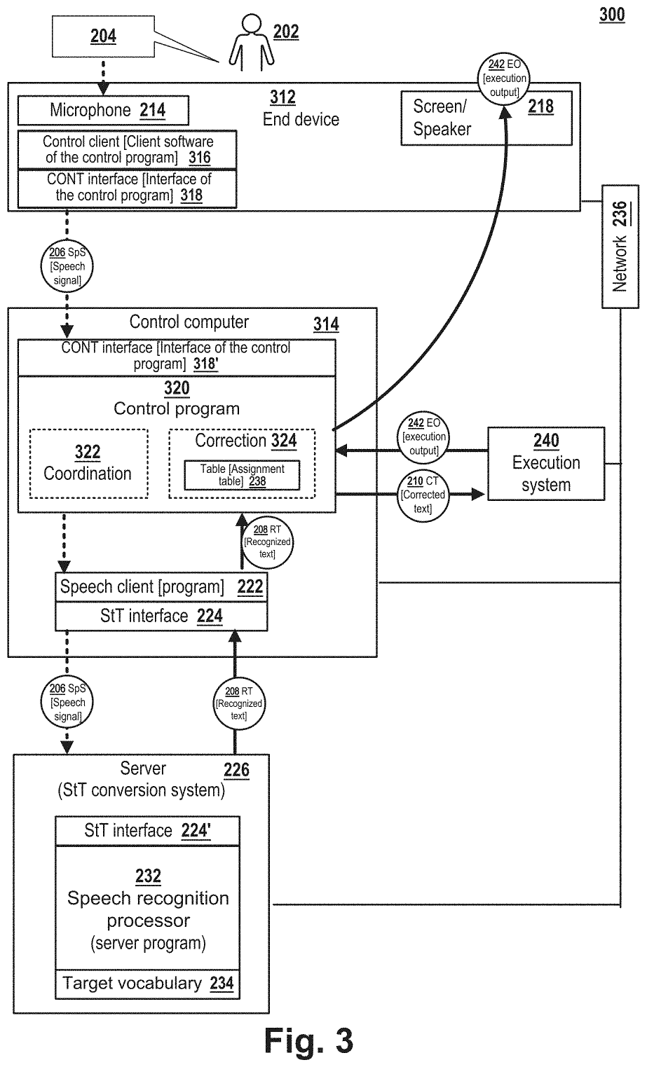

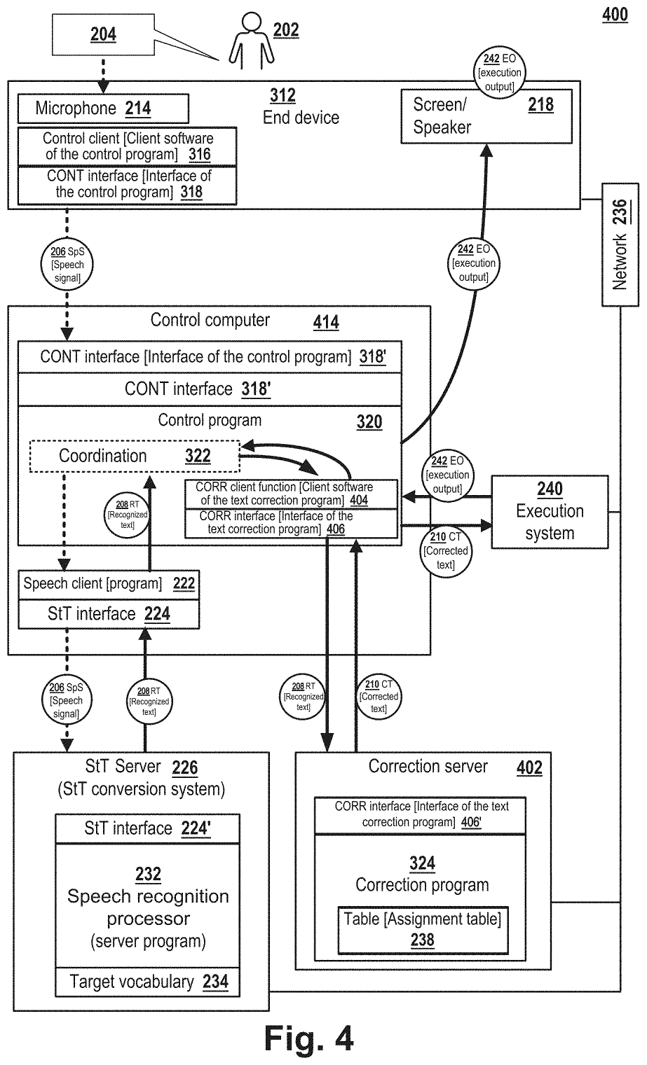

For example, as shown in FIG. 2, the end device may have an interface 224 and a client application 222 corresponding to one of the known general language speech-to-text conversion systems 226 from, for example, Google, Apple, Amazon, or Nuance. This client application 222 transmits the speech signal via interface 224 directly to speech-to-text conversion system 226. However, in other embodiments, it is also possible that the speech signal is transmitted to speech-to-text conversion system 226 via one or more intermediary data processing devices. According to the embodiments of the invention depicted in FIGS. 3 and 4, the speech signal is initially transmitted to a control computer 314, 414, which then forwards it to speech-to-text conversion system 226 via a network 236. This network may be, for example, the internet.

Control computer system 314, 414 executes coordination and control activities related to the management and processing of the speech signal and the text generated from the same. Control computer 314 is a data processing system which executes the text correction itself. Control computer 414 has outsourced this computing step to another data processing system.

Speech-to-text conversion system 226 is a general language conversion system, i.e., it only supports the conversion of speech signals into a general language target vocabulary 234, which does not contain the technical language terms of speech input 204.

The speech-to-text conversion system now carries out the conversion of the speech signal into a text based on the target vocabulary. Typically, speech-to-text conversion system 226 is a cloud service, which may process a plurality of speech signals of multiple end devices in parallel and may return these to the same via the network. However, the generated text—regardless of how the speech-to-text conversion system is implemented—certainly, or with a high degree of probability, contains incorrectly recognized terms and expressions, since at least some of the terms and expressions of speech input 204 comprise technical language terms or expressions, whereas the conversion system only supports the target vocabulary, which does not contain the technical language terms and expressions.

In step 106, that data processing system, which transmitted speech signal 206 to speech-to-text conversion system 226, receives, as a response thereto, text 208, generated by the speech-to-text conversion system from this signal. The data processing system functioning as the receiver (“receiving system”) may thus be, depending on the system architecture, the end device, or a control computer 314, as shown in FIG. 3, or a control computer 414, as shown in FIG. 4.

In another step 108, an assignment table 238 is used in order to correct the received text. The data processing system, which carries out the text correction, is also designated according to its function in this case as the “correction system”. This may be, depending on the embodiment, end device 212, or control computer system 314 or a correction computer system 402. In the case that the receiving system and the correction system are not identical, text 208, received by the receiving system, is forwarded to the correction computer system.

In assignment table 238, terms are assigned to one another in text form. Stated more precisely, the assignment table assigns at least one term from the target vocabulary to each of a plurality of technical language terms or technical language expressions. The at least one term of the target vocabulary, assigned to a technical language term (or technical language expression), is a term or an expression, which the speech-to-text conversion system incorrectly recognizes (and has incorrectly recognized earlier during the generation of the assignment table), when this technical language term is input into the speech-to-text conversion system in the form of an audio signal.

In step 108, correction system 212, 314, 402 generates a corrected text 210 from incorrect text 208 of conversion system 226. The corrected text is automatically generated by the correction system, in that terms and expressions of the target vocabulary in received text 208 are replaced with technical language terms according to assignment table 238.

In the case that the correction system is a correction computer, as shown in FIG. 4, the corrected text is returned to a control computer.

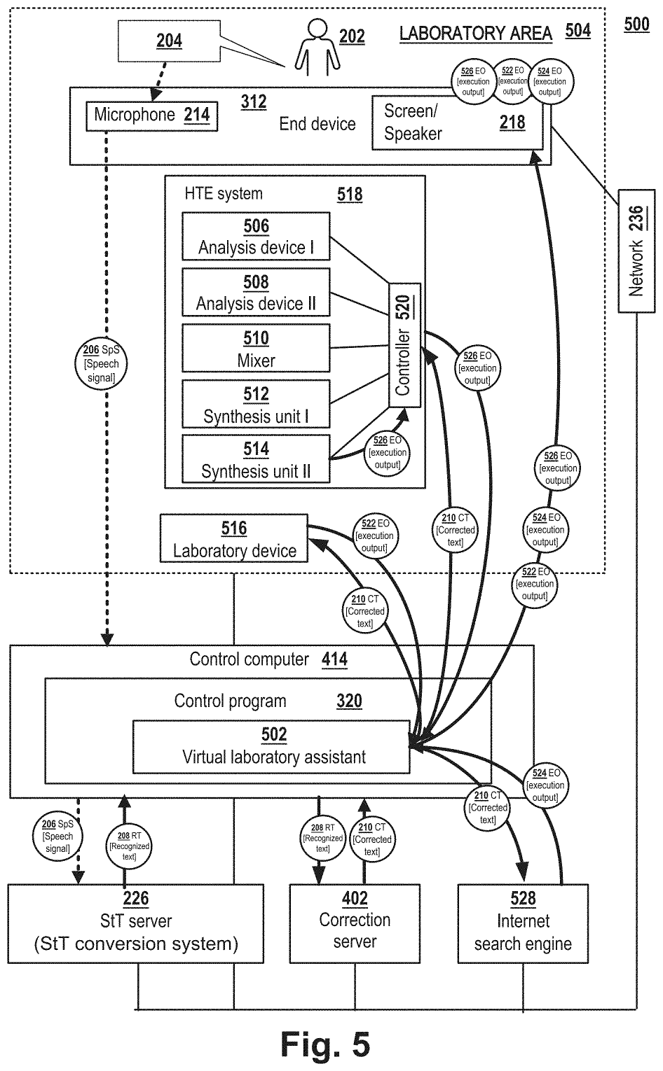

The end device or the control computer inputs corrected text 210 directly or indirectly into an execution system 240 in step 110. Examples for different execution systems are depicted in FIG. 5. The execution system, a software component and/or a hardware component, executes a software function and/or hardware function according to the corrected text and returns result 242. The result may be returned, for example, directly to the end device or may be returned to the end device via the control computer as an intermediate station. Alternatively or additionally, however, the result may also be returned to different end devices and other data processing systems.

In the embodiments depicted in FIGS. 3 and 4, control computer 314, functioning as the correction system, transmits the corrected text to execution system 240, receives result 242 of the execution by the same, and forwards this result to the end device to be output to user 202. The result is typically a text, e.g., a recipe, researched in a database, for the synthesis of a chemical substance; a document, e.g. product data sheet of a substance, identified in a database or the internet; the confirmation that a chemical analysis or synthesis, which was carried out according to the information in the corrected text, was successfully completed (or, if this was not the case, a corresponding error message).

Finally, the end device or another data processing system may output the result of carrying out the function by execution system 240, comprising software and/or hardware, to user 202. The software and/or the hardware is preferably software and hardware, which are developed inside of a laboratory or specifically for activities inside of a laboratory, or which are at least usable for this.

For example, end device 212 may include a speaker or may be communicatively coupled to the same and may output the result in acoustic form via this speaker.

Additionally or alternatively, the end device may include a screen to output the result to the user. Additional output interfaces are also possible, for example, Bluetooth-based components.

For example, the method according to embodiments of the invention may function for implementing voice control of electronic devices, in particular laboratory instruments and HTE systems by means of voice control. The voice control may also be used in order to research and to output results from analyses and syntheses, already carried out in the laboratory, laboratory protocols and product data sheets in corresponding databases of the laboratory, and to carry out voice-controlled supplemental searches both on the internet and in public and proprietary databases accessible via the internet. Voice commands, which include specific trade names of chemicals or laboratory devices or laboratory consumables and/or names and adjectives of the chemical technical language, are also correctly converted into text and may thus be correctly interpreted by the execution system. According to embodiments of the invention, a largely voice-controlled, highly integrated operation of a chemical or biological laboratory or a laboratory HTE system is thus facilitated. The term “CONTROL COMPUTER” in the speech input may, for example, represent the name of a virtual assistant 502 for speech-based operation of the devices of a laboratory and/or an HTE system of a laboratory. Analogous to the virtual assistants Alexa and Siri for everyday problems, the term “CONTROL COMPUTER” (or, optionally, any other name more reminiscent of a human being, like “EVA”) may function as a trigger signal to prompt a text evaluation logic of this laboratory assistant to evaluate the corrected text. The laboratory assistant is configured to subsequently check each received text, for whether this text includes its name and, optionally, other key terms. If this is the case, then the corrected text is further analyzed to recognize and execute commands encoded therein.

According to one embodiment, the output of the results data, which was determined on the basis of the corrected text input into the laboratory device or the HTE system, is carried out via a speaker, which is located within the laboratory room. For example, the speaker may be a speaker, which is a component of the end device that received the speech input of the user. This may, however, also be a different speaker, which is communicatively connected to this end device. This has the advantage that a laboratory worker may seamlessly enter commands with their voice, for example, about analysis results, product data sheets or another context, to quickly find out information for chemical analyses, syntheses, and products. The results of this verbal search instruction are acoustically output via the speaker. The user may use the heard information in order to formulate additional search commands and/or to speak a voice command into the microphone to carry out an analysis or synthesis while taking into account the acoustically-output research results. This cycle of acoustic input and output may be repeated multiple times without necessitating an input of data or commands via a keyboard for this. However, laboratory process may be configured substantially more efficiently.

In the context of the chemical synthesis of paints and lacquers, efficiently obtaining information related to chemical substances and a voice-based control of laboratory devices and HTE systems is particularly advantageous, as a large plurality of raw materials is necessary for the production of paints and lacquers, wherein their properties interact with one another in complex ways and strongly influence the properties of the product. Thus, a plurality of analyses, control steps, and test series arise in the context of the production of paints and lacquers. Paints and lacquers are highly complex mixtures of up to 20 raw materials and more, for example, solvents, resins, curing agents, pigments, fillers, and numerous additives (dispersing agents, wetting agents, adhesion promoters, defoamers, biocides, flame retardants, and others). An efficient procurement of information related to the individual components and for controlling the corresponding analysis and synthesis systems may substantially accelerate the production process and the quality assurance of the products.

FIG. 2 shows a block diagram of a distributed system 200 for the speech-to-text. conversion of texts with technical language terms.

The essential functions of the components of system 200 and its components were already described with reference to FIG. 1. End device 212 may be, for example, a notebook computer, a standard computer, a tablet computer, or a smartphone. Client software 222, which is interoperable with an existing general language speech-to-text conversion system 226, is installed on the end device. For example, speech-to-text conversion system 226 is a cloud computer system, which offers the conversion as a service over the internet via a corresponding speech-to-text interface (StT interface) 224. This service is a software program 232, implemented on the server side and which corresponds in a functional perspective to a speech recognition and speech conversion processor. For example, software program 232 may be Google's speech-to-text cloud service. Interface 224 is, in this case, a cloud-based API from Google.

In the embodiment depicted in FIG. 2, the end device has an assignment table 238 and sufficient computing power to itself carry out the correction, based on the table, of text 208 generated by speech-to-text conversion system 226. The transmission of speech signal 206 to server 226, the receipt of text 208 from server 226, and the correction of the text to generate corrected text 210, may thus be implemented in client program 222. Client program 222 may be, for example, a browser plugin or a standalone application, which is interoperable with server software 232 via interface 224.

FIG. 3 shows a block diagram of another distributed system 300 for the speech-to-text conversion.

The essential functions of system 300 and its components were already described with reference to FIG. 1 and FIG. 2. The system architecture of system 300 differs from the architecture of system 200 to the effect that end device 312 has outsourced the function of the text correction to a control computer 314. Client software 316, installed on end device 312 and called control client in this case, is interoperable with a corresponding control program 320, which is installed on control computer 314. The end device is connected to control computer 314 via a network 236, for example, the internet. Control interface 318 functions for data exchange between control client 316 and control program 320.

Control computer 314 may be, for example, a standard computer. However, the control computer is advantageously a server or a cloud computer system.

Control program 320, installed on the control computer, first implements a coordinative function 322 in order to coordinate the exchange of data (speech signal 206, recognized text 208, corrected text 210) between the various data processing devices (end device, control computer, speech-to-text conversion system). Secondly, in the embodiment shown here, control program 320 implements a text correction function 324, which is executed in system 200 by the end device. Correction function 324 comprises the replacement of terms and expressions of the target vocabulary in received text 208 with technical language terms and expressions according to assignment table 238. In addition, over the course of the replacement, probabilities of occurrence and/or POS tags may be taken into consideration, which are calculated by control computer 314 or are received via StT interface 224 from speech-to-text conversion system 226 together with text 208. Speech client 222, which in this embodiment only controls the data exchange with conversion system 226 and does not carry out the text correction, may be implemented as a component of control program 320. However, it is also possible that control program 320 and client 222 are separate but mutually interoperable programs.

The architecture depicted in FIG. 3 has the advantage that the end device does not have to execute any computationally intensive operations. Both the conversion of the speech signal into text and also the correction of this text are taken over by other data processing systems. The function of end device 312 is substantially limited to the receipt of speech signal 206, forwarding the speech signal to a predefined control computer 314 with a known address, and the output of a result, which is returned from an execution system for carrying out a function according to the corrected text.

FIG. 4 shows a block diagram of another distributed system 400 for the speech-to-text conversion.

The essential functions of system 400 and its components were already described with reference to FIGS. 1, 2, and 3. The system architecture of system 400 differs from the architecture of system 300 to the effect that control computer 414 does not itself undertake the text correction, but instead has it carried out by another computer, designated here as “correction computer” or “correction server” 402, wherein other computer 402 is interoperably connected to control program 320 of the control computer via a network and an intrinsic interface 406.

This architecture may be advantageous, since a separate computer or computer network, which may be designed as a cloud system, is used for the text correction. This enables a separate granting of access rights. Control program 320 on control computer 414 may, for example, have comprehensive access rights with respect to different, sometimes sensitive data, which is generated over the course of the analysis and synthesis of chemical substances and substance mixtures in the laboratory, for example, using an HTE system. According to embodiments of the invention, control computer 414 may have, for example, a machine-to-machine interface in order to transmit the corrected text, in the form of a control command, directly to a laboratory device or an HTE system, or to its database in order to initiate an analysis, chemical synthesis, or research, based on corrected text 210. Secure and strict access protection for control computer 414 is therefore particularly important.

In the context of the architecture of system 400, correction server 402 only functions to correct text 208, which was generated by speech-to-text conversion system 226 and returned to control program 320. A user, who receives access to correction server 402, for example, in order to update and supplement table 238 with additional technical terms and technical expressions, thus has no read and/or write access to control computer 414 according to embodiments of the invention. It is thus possible to continuously update the assignment table and thus the text correction, without necessitating the granting of comprehensive access rights to sensitive control logic and databases of a laboratory to the personnel responsible for this.

End device 312 of distributed systems 300, 400 may be, for example, computers, notebook computers, smartphones, and the like. However, it is also possible that this is comparatively computationally weak single-board computers, e.g., Raspberry Pi systems.

The hardware (smart speakers) of known speech-to-text cloud services providers, pursue the objective to directly control and use services developed by the cloud providers themselves. The use in the area of technical vocabulary is currently not developed or developed only to a very limited extent.

All of system architectures 200, 300, 400, and 500, shown here, allow the use of existing speech-to-text APIs of diverse cloud providers by means of separate hardware, independent of the cloud provider, in order to enable subject-specific speech recognition and, based on this, to control laboratory devices and electronic search functions in a laboratory.

FIG. 5 shows a block diagram of another distributed system 500 for the speech-to-text conversion in the context of a chemical laboratory. The laboratory comprises a laboratory area 504 with conventional safety regulations. Different individual laboratory devices 516, e.g., a centrifuge and an HTE system 518, are located in this area. The HTE system includes a plurality of modules and hardware units 506-514, which are managed and controlled by a controller 520. The controller functions as the central interface for external monitoring and control of the devices included in the HTE system. Control program 320 on control computer 414 includes a software module 502, which implements a virtual laboratory assistant.

The generation of a corrected text 210 from a speech input 204 of a user 202 is carried out as already described according to embodiments of the invention. After control program 320 has received the corrected text from correction computer 402, the control program evaluates this and thereby searches for a keyword, like “CONTROL COMPUTER” or “EVA”. In the case that the corrected text contains this keyword, then virtual laboratory assistant 502 is subsequently prompted to further analyze the corrected text to see whether the corrected text contains commands to carry out a hardware or software function and, if yes, which hardware or software, controlled by laboratory assistant 502, should execute these commands. For example, the corrected text may contain names of devices or laboratory areas, which specify to which device or to which software the command should be forwarded.

In one possible implementation example, the evaluation of corrected text 210 by the virtual laboratory assistant yields that an internet search engine 528 is to search for a certain substance, which is specified as a technical language term or expression in corrected text 210. The corrected text or certain parts thereof are input by virtual assistant 502 into the search engine via the internet. Results 524 of the internet research are returned to assistant 502, which forwards them to a suitable output device in the vicinity of user 202, for example, end device 312, where they are output via a speaker or screen 218.

In another possible implementation example, the evaluation of corrected text 210 by the virtual laboratory assistant yields that laboratory device 516, a centrifuge, should pelletize a certain material at a certain rotational speed. The name of the centrifuge and the material are specified in corrected text 210 as a technical language term or expression, which is sufficient, since the centrifuge automatically reads the centrifugation parameters to be used, like duration and number of revolutions, from an internal database based on the substance names. The corrected text or certain parts thereof are transmitted by virtual assistant 502 to centrifuge 516 via the internet. The centrifuge starts a centrifugation program, related to the substance, and returns a message about the successful or unsuccessful centrifugation as a text message 522. Result 522 is returned to assistant 502, which forwards this to a suitable output device, for example, end device 312, where it is output via a speaker or screen 218.

In another possible implementation example, the evaluation of corrected text 210 by the virtual laboratory assistant yields that HTE system 518 should synthesize a certain lacquer. The components of the lacquer are likewise specified in the corrected text and comprise a mixture of trade names of chemical products and IUPAC substance names. The HTE system receives corrected text 210 and autonomously decides to carry out the synthesis in synthesis unit 514. A message about the successful synthesis or an error message is returned as result 526 from synthesis unit 514 to the controller of HTE system 518, and the controller in turn returns result 526 to virtual laboratory assistant 502, which forwards it to a suitable output device, for example, end device 312, where it is output via a speaker or screen 218.

### LIST OF REFERENCE NUMERALS

102-110 Steps
200 Distributed system
202 User
204 Speech input
206 Speech signal
208 Recognized text
210 Corrected text
212 End device
214 Microphone
216 Processor(s)
218 Screen
220 Storage medium
222 Client program
224 Interface (client side)
224′ Interface (server side)
226 Speech-to-text conversion system/Cloud system
228 Processor(s)
230 Storage medium
232 Speech recognition processor
234 Target vocabulary
236 Network
238 Assignment table
240 Execution system (software and/or hardware)
242 Result of the execution of the corrected text (in text form)
300 Distributed system
312 End device
316 Client software of the control program
318 Interface of the control program
320 Control program
322 Coordination function
324 Text correction function/Text correction program
400 Distributed system
402 Correction server/Text correction cloud system
404 Client software of the text correction program
406 Interface of the text correction program
414 Control computer
500 Distributed system
502 Virtual laboratory assistant
504 Laboratory area
506 Analysis device
508 Analysis device
510 Mixer
512 Synthesis unit
514 Synthesis unit
516 Standalone laboratory device
522 Result of the execution of the corrected text (text form)
524 Result of the execution of the corrected text (text form)
526 Result of the execution of the corrected text (text form)
528 Internet search engine

1. A computer-implemented method for converting speech to text, including:
receipt (102) by an end device (212) of a speech signal (206) of a user (202), wherein the speech signal contains general language terms and technical language terms spoken by the user;
input (104) of the received speech signal into a speech-to-text conversion system (226), wherein the speech-to-text conversion system only supports the conversion of speech signals into a target vocabulary (234) which does not contain the technical language terms;
receipt (106) from the speech-to-text conversion system of a text (208), which was generated by the speech-to-text conversion system from the speech signal;
generation (108) of a corrected text (210) by automatically replacing terms and expressions from the target vocabulary in the received text with technical language terms according to an assignment table (238) of terms in text form, wherein the assignment table assigns at least one term from the target vocabulary to each of a plurality of technical language terms, wherein the at least one term of the target vocabulary, assigned to one technical language term, is a term or an expression, which the speech-to-text conversion system incorrectly recognizes when this technical language term is entered in the form of an audio signal; and
output (110) of the corrected text to the user and/or to software (528/240) and/or to a hardware component (506-516, 240), wherein the software or hardware component is configured to execute a function according to information in the corrected text.

2. The computer-implemented method according to claim 1, wherein the generation of the corrected text is carried out by a correction system, wherein the correction system is the end device (212) or a correction computer system (314, 402) operatively connected to the end device via a network.

3. The computer-implemented method according to one of the preceding claims,
wherein the target vocabulary comprises a quantity of general language terms; or
wherein the target vocabulary comprises a quantity of general language terms and terms derived therefrom; or
wherein the target vocabulary comprises a quantity of general language terms, supplemented by terms derived therefrom and/or supplemented by terms which are formed by combinations of recognized syllables.

4. The computer-implemented method according to one of the preceding claims, wherein the technical language terms are terms from one of the following categories:
names of chemical substances, especially paints and lacquers or additives in the paint and lacquer sector;
physical, chemical, mechanical, optical, or haptic properties of chemical substances;
names of laboratory devices and equipment in the chemical industry;
names of laboratory consumables and laboratory supplies;
trade names in the paint and lacquer sector.

5. The computer-implemented method according to one of the preceding claims, further comprising:
receipt or calculation of frequency information, wherein the frequency information for at least some of the terms in the text, which was generated by the speech-to-text conversion system from the speech signal, indicates how often the occurrence of this term is to be statistically expected;
wherein, during the generation of the corrected text, only those terms of the target vocabulary in the received text, whose statistically-expected frequency of occurrence lies below a predefined threshold value according to the received frequency information, are replaced by technical language terms according to the assignment table.

6. The computer-implemented method according to claim 5,
wherein the calculation of the frequency information is carried out by means of a hidden Markov model.

7. The computer-implemented method according to one of the preceding claims, further comprising:
receipt of part-of-speech tags—POS tags—for at least some of the terms in the text, which were generated by the speech-to-text conversion system from the speech signal, wherein the POS tags contain at least tags for noun, adjective, and verb;
wherein the technical language terms of the assignment table are stored together with the part-of-speech tags of the technical language terms;
wherein, during the generation of the corrected text, only those terms of the target vocabulary in the received text are replaced by technical language terms, whose POS tags match, according to the assignment table.

8. The computer-implemented method according to one of the preceding claims, further comprising:
for each of a plurality of technical language terms, recording of at least one reference speech signal, which selectively reproduces this technical language term, by at least one speaker;
input of each of the reference speech signals into the speech-to-text conversion system;
for each of the entered reference speech signals, receipt from the speech-to-text conversion system of at least one term of the target vocabulary, which was generated by the speech-to-text conversion system from the entered reference speech signal, wherein each of the received terms of the target vocabulary represents an incorrect conversion, since the target vocabulary of the speech-to-text conversion system does not support the technical language terms;
wherein the assignment table assigns the at least one term of the target vocabulary in text form, which was respectively generated by the speech-to-text conversion system from the reference speech signal containing this technical language term, to each of the technical language terms and expressions, for which at least one reference speech signal was recorded.

9. The computer-implemented method according to claim 8:
wherein multiple reference speech signals are respectively spoken and recorded by different speakers for at least some of the technical language terms, wherein the multiple reference speech signals reproduce this technical language term;
wherein the assignment table assigns multiple terms of the target vocabulary in text form to each of the at least some of the technical language terms, wherein the multiple terms of the target vocabulary represent incorrect conversions, which the speech-to-text conversion system generated for the different speakers depending on their voices.

10. The computer-implemented method according to one of the preceding claims, wherein the output of the corrected text to the user is carried out and comprises:
display of the corrected text on a screen (218) of the end device; and/or
output of the corrected text via a text-to-speech interface and a speaker of the end device.

11. The computer-implemented method according to one of the preceding claims, wherein the output of the corrected text is carried out to the software, wherein the software is selected from a group comprising:
a chemical substance database, which is designed to interpret the corrected text as a search input and to determine and return information related to the search input in the database; and/or
an internet search engine, which is designed to interpret the corrected text as a search input and to determine and return information from the internet related to the search input; and/or
simulation software, which is designed to simulate properties of chemical products, in particular of lacquers and paints, based on a predetermined recipe, wherein the simulation software is designed to interpret the corrected text as a specification of a recipe of a product, whose properties are to be simulated;
control software for controlling chemical syntheses and/or the generation of substance mixtures, in particular of paints and lacquers, wherein the control software is designed to interpret the corrected text as a specification of the synthesis or of the components of the substance mixture.

12. The computer-implemented method according to one of the preceding claims, further comprising:
output of a result of executing the function by the software or hardware component via a speaker or a screen of the end device.

13. The computer-implemented method according to one of the preceding claims,
wherein the output of the corrected text is carried out to the hardware component,
wherein the hardware component is a system for carrying out chemical analyses, chemical syntheses, and/or for generating substance mixtures, in particular of paints and lacquers,
wherein the system is designed to additionally interpret the corrected text as a specification of the synthesis or of the components of the substance mixture or as a specification of the analysis.

14. The computer-implemented method according to one of the preceding claims,
wherein the speech-to-text conversion system is implemented as a service which is provided via the internet to a plurality of end devices; and/or
wherein the end device is a desktop computer, notebook computer, smartphone, a computer integrated into a laboratory device, a computer coupled locally to a laboratory device, or a single-board computer (Raspberry Pi).

15. An end device (212), comprising:
a microphone (214) for receiving a speech signal (206) of a user, wherein the speech signal contains general language terms and technical language terms spoken by the user;
an interface (224) to a speech-to-text conversion system (226),
wherein the interface is designed to input the received speech signal into the speech-to-text conversion system, wherein the speech-to-text conversion system only supports the conversion of speech signals into a target vocabulary (234) which does not contain the technical language terms; and
wherein the interface is designed to receive a text (208), which was generated by the speech-to-text conversion system from the speech signal;
a data memory (220) with an assignment table (238) of terms in text form, wherein the assignment table assigns at least one term from the target vocabulary to each of a plurality of technical language terms, wherein the at least one term of the target vocabulary assigned to a technical language term is a term or an expression, which the speech-to-text conversion system incorrectly recognizes when this technical language term is entered in the form of an audio signal; and
a correction program (222), which is designed to generate a corrected text (210) by automatically replacing terms and expressions of the target vocabulary in the received text with technical language terms according to the assignment table; and
an output interface (218) to output (110) the corrected text to the user and/or to software (528/240) and/or to a hardware component (506-516, 240), wherein the software or hardware component is configured to execute a function according to information in the corrected text.

16. A system including one or more end devices (212) according to claim 15, further comprising a speech-to-text conversion system (226), wherein the speech-to-text conversion system includes:
an interface (224′) for receiving speech signals (206) from each of the one or more end devices;
an automatic speech recognition processor (232) for generating text (208) from a received speech signal (206), wherein the speech recognition processor only supports the conversion of speech signals into a target vocabulary (234), which does not include the technical language terms; and
wherein the interface is designed to return the text (208), generated from the received speech signal, to that end device, from which the speech signal was received.
